(19) United States
(12) Patent Application Publication
(10) Pub. No.: US 2018/0041683 A1
(43) Pub. Date: Feb. 8, 2018

(54) HIGH-DYNAMIC-RANGE SENSING DEVICE AND SENSING METHOD THEREOF

(71) Applicant: NATIONAL TSING HUA UNIVERSITY, HSINCHU (TW)

(72) Inventors: YEN-YIN LIN, HSINCHU (TW); ANN-SHYN CHIANG, HSINCHU (TW); AN-LUN CHIN, HSINCHU (TW); YUAN-YAO LIN, HSINCHU (TW)

(21) Appl. No.: 15/785,642

(22) Filed: Oct. 17, 2017

Related U.S. Application Data
(62) Division of application No. 14/510,358, filed on Oct. 9, 2014.

(30) Foreign Application Priority Data
Jun. 20, 2014 (TW) 103121321

(51) Int. Cl. H04N 5/235; H04N 5/225; H04N 5/355

(52) U.S. Cl. CPC H04N 5/2355; H04N 5/35563; H04N 5/2254; H04R 3/005

(57) ABSTRACT

The present invention provides a high-dynamic-range sensing device and the sensing method thereof. The high-dynamic-range sensing device includes a control unit and sensing units with different sensing ranges. In the sensing method, the sensing units give sensing values, and then the control unit compares the sensing values and the upper sensing limit of the sensing units, respectively. When a sensing value is equal to the upper sensing limit, the control unit rejects the sensing value or interrupts the sensing of the sensing unit thereof. Thereby, the sensing device quickly excludes the sensing units which obtain saturated signals and their sensing values and thus switches between the alternative sensing units with different sensing ranges or picks up the optimum one of the sensing values.

### CROSS-REFERENCE TO RELATED APPLICATION

This application is a Divisional application of U.S. patent application Ser. No. 14/510,358, filed on 9 Oct. 2014, currently pending, which is based on Taiwan patent application Ser. No. 103121321, filed on 20 Jun. 2014, which are incorporated by reference.

### FIELD OF THE INVENTION

The present invention relates generally to a high-dynamic-range sensing device and the sensing method thereof, and particularly to a high-dynamic-range sensing device and the sensing method thereof that uses a control unit to rapidly abandon saturated sensing values from those given by a plurality of sensing units with different sensing ranges and switch among sensing units for achieving high-dynamic-range sensing.

### BACKGROUND OF THE INVENTION

Animals always face a great deal of environmental information. Given the limited resources of energy and materials inside their bodies, it is not possible that they respond to all the stimuli from the environment. Instead, the information collected by sensory organs should be sifted before they can respond to important stimuli by using resources appropriately and thus extending their subsistence.

In the process when stimuli are transferred from the sensory nerves to the sensory centers, two types of sifting occur. One type of sifting occurs in the periphery nervous system for eliminating unnecessary environmental information at the sensory stage. The other occurs in the central nervous system for further sifting the information. For example, after odor molecules contact the cells in the antennal lobe of fruit flies, the signals will be transmitted to the glomeruli for noise filtering and signal strengthening. Then the signals will be transmitted to the mushroom bodies for signal analysis and judgment. Finally, the signals are transmitted to higher levels of the brain. Consequently, fruit flies can make dodging or approaching response to the source of odors.

In the nervous system of animals, signals can be sifted and responded rapidly using the feedback and inhibition among signal paths. The present inventor is inspired by the mechanism and provides a sensing device capable of selecting among multiple sensing units or the acquired multiple sensing values. By arranging the distribution of the sensing ranges of respective sensing units, the efficacy of high dynamic range can be attained.

### SUMMARY

Accordingly, the present invention provides a high-dynamic-range sensing device and the sensing method thereof. The device comprises at least two sensing units having different sensing ranges and acquiring respective sensing values while sensing the target signal. In addition, a control unit is used for accepting or rejecting the sensing values or switching among the sensing units. In order to simply judgment, the control unit first rejects the sensing values of the sensing unit with saturated signals. Then it selects the most sensitive sensing unit among the ones without saturated signals.

### SUMMARY

An objective of the present invention is to provide a high-dynamic-range sensing device, which uses a control unit to accept or reject the sensing values given by sensing units having different sensing ranges or switch among the sensing units for achieving high-dynamic-range sensing.

Another objective of the present invention is to provide a sensing method of high-dynamic-range sensing device, which uses a control unit to first reject the sensing values of the sensing units having saturated signals or interrupt their sensing for achieving accepting or rejecting sensing values rapidly or switching sensing units.

In order to achieve the objectives and efficacies described, the present invention discloses a high-dynamic-range sensing device, which comprises a first sensing unit, a second sensing unit, and a control unit. The first sensing unit has a first sensing upper limit, senses a target signal, and gives a first sensing value. The second sensing unit has a second sensing upper limit, which is greater than the first sensing upper limit, senses the target signal, and gives a second sensing value. The control unit is connected electrically to the first and second sensing units, receives the first and second sensing values, and rejects the first sensing value when the first sensing value is equal to the first sensing upper limit.

In addition, the present invention discloses a sensing method of high-dynamic-range sensing device applicable to the high-dynamic-range sensing device described above. First, the first and second sensing units sense the target signal and give the first and second sensing values. Next, the control unit receives the first and second sensing units and compares the first sensing value and the first sensing upper limit. If the first sensing value is equal to the first sensing upper limit, the control unit rejects the first sensing value; if the first sensing value is smaller than the first sensing upper limit, the control unit rejects the second sensing value.

Moreover, the present invention discloses another high-dynamic-range sensing device, which also comprises a first sensing unit, a second sensing unit, and a control unit. The difference is that the control unit further comprises a third sensing unit, which senses the target signal and gives a third sensing value. Then the control unit rejects the first sensing value or interrupts the sensing of the first sensing unit when the third sensing value is greater than or equal to the first sensing upper limit.

Besides, the present invention discloses another sensing method of high-dynamic-range sensing device application to the second high-dynamic-range sensing device described above. First, the first, second, and third sensing units sense the target signal and give the first, second, and third sensing values. Next, the control unit receives the first and second sensing values and compares the third sensing value and the first sensing upper limit. If the third sensing value is greater than or equal to the first sensing upper limit, the control unit rejects the first sensing value; if the third sensing value is smaller than the first sensing upper limit, the control unit rejects the second sensing value.

### BRIEF DESCRIPTION OF THE DRAWINGS

FIG. 1A shows a schematic diagram of component connection according to a preferred embodiment of the present invention;

FIG. 1B shows a flowchart according to a preferred embodiment of the present invention;

FIG. 1C shows a schematic diagram of device structure according to a preferred embodiment of the present invention;

FIG. 2A shows a schematic diagram of component connection according to another preferred embodiment of the present invention;

FIG. 2B shows a flowchart according to another preferred embodiment of the present invention;

FIG. 2C shows a schematic diagram of device structure according to another preferred embodiment of the present invention;

FIG. 3A shows a schematic diagram of component connection according to still another preferred embodiment of the present invention;

FIG. 3B shows a flowchart according to still another preferred embodiment of the present invention; and

FIG. 3C shows a schematic diagram of device structure according to still another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides sensing device and the sensing method thereof characterized in that the control unit is used for comparing the sensing values of the sensing units and the sensing upper limits and rejecting rapidly the sensing values equal to the sensing upper limits for excluding the sensing units having saturated signals with respect to the target signal. Thereby, switching occurs among the sensing units having different sensing ranges. Alternatively, the most appropriate sensing value is selected from the sensing values. By arranging the sensing ranges of the sensing units, the effect of high-dynamic-range sensing can be achieved.

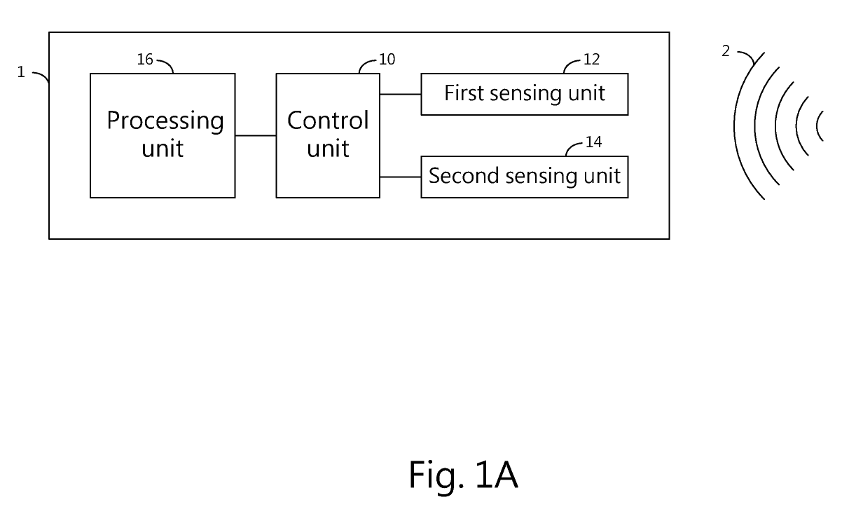

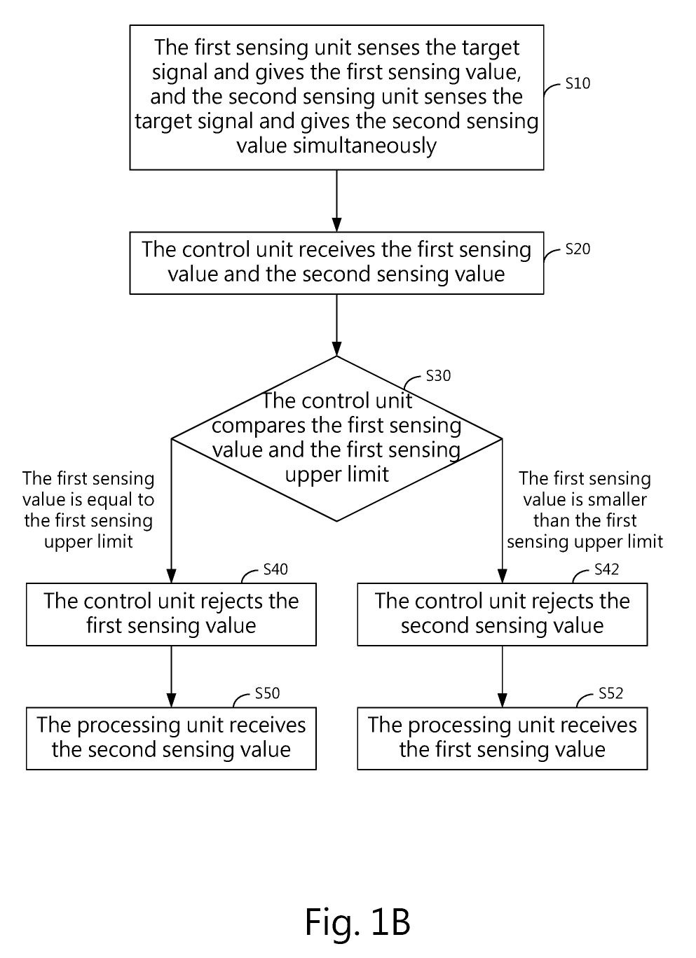

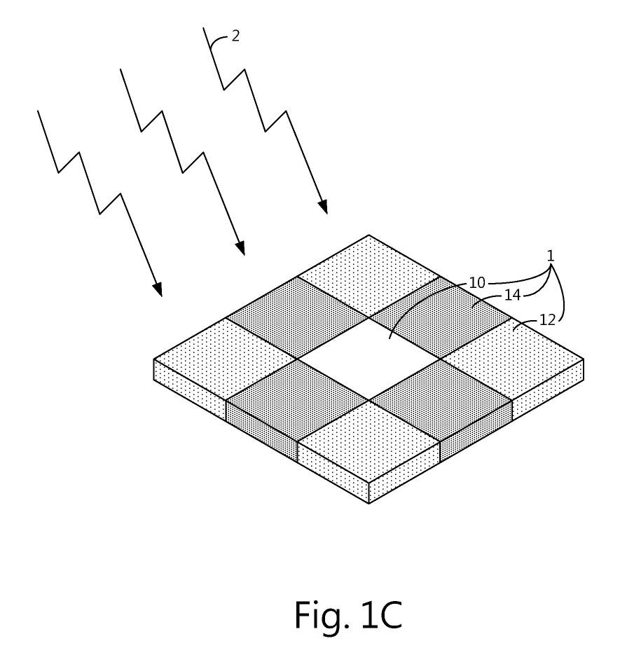

Please refer to FIGS. 1A, 1B, and 1C, which show a schematic diagram of component connection, a flowchart, and a schematic diagram of device structure according to a preferred embodiment of the present invention. As shown in FIG. 1A, the high-dynamic-range sensing device 1 according to the present invention is used for measuring a target signal 2. The high-dynamic-range sensing device 1 at least comprises a control unit 10, a first sensing unit 12, and a second sensing unit 14. The first and second sensing units 12, 14 are connected electrically with the control unit 10, respectively.

The first and second sensing units 12, 14 sense the target signal 2 simultaneously and give a first sensing value and a second sensing value, respectively. The first and second sensing values are transmitted to the control unit 10.

The upper limit of the first sensing unit 12 for sensing signal is a first sensing upper limit; the lower limit thereof is a first sensing lower limit. The range between the first sensing lower limit and the first sensing upper limit is called a first sensing range of the first sensing unit 12. Besides, the upper limit of the second sensing unit 14 for sensing signal is a second sensing upper limit; the lower limit thereof is a second sensing lower limit. The range between the second sensing lower limit and the second sensing upper limit is called a second sensing range of the second sensing unit 14.

The first sensing upper limit is smaller than the second sensing upper limit, which means that the first sensing unit 12 is easier to reach signal saturation than the second sensing unit 14. When the real value of the target signal 2 is greater than or equal to the first sensing upper limit, the first sensing value is equal to the first sensing upper limit, the signal is saturated and the real value of the target signal 2 cannot be represented. At this time, if the real value of the target signal 2 is still smaller than the second sensing upper limit and within the second sensing range, the second sensing value can be used for representing the real value of the target signal 2.

According to the present embodiment, the first sensing lower limit is smaller than the second sensing lower limit, which means that the first sensing unit 12 is more sensitive than the second sensing unit 14. In addition, the second sensing lower limit is smaller than the first sensing upper limit. By arranging and linking the first and second sensing ranges, a wider range of the real value of the target signal 2 can be covered, and thus achieving high-dynamic-range sensing.

Accordingly, when the first sensing value is equal to the first sensing upper limit, the first sensing unit 12 has reached signal saturation. Then the control unit 10 rejects the first sensing value and accepts the second sensing value. On the contrary, when the first sensing value is smaller than the first sensing upper limit, the control unit 10 rejects the second sensing value and accepts the first sensing value.

As shown in FIG. 1B, the sensing method of high-dynamic-range sensing device according to the present invention at least comprises the following steps:
Step S10: The first sensing unit senses the target signal and gives the first sensing value, and the second sensing unit senses the target signal and gives the second sensing value simultaneously;
Step S20: The control unit receives the first sensing value and the second sensing value;
Step S30: The control unit compares the first sensing value and the first sensing upper limit;
Step S40: The control unit rejects the first sensing value; and
Step S42: The control unit rejects the second sensing value.

In the step S10, while sensing the target signal 2 using the high-dynamic-range sensing device 1 according to the present invention, the first and second sensing units 12, 14 sense the target signal 2 simultaneously and, as described above, give the first and second sensing values, respectively. In the step S20, the first and second sensing units 12, 14 transmit the first and second sensing values to the control unit 10, respectively. The control unit 10, as in the step S30, compares the first sensing value and the first sensing upper limit for accepting or rejecting the first and second sensing values.

As described above, when the first sensing value is equal to the first sensing upper limit, it means that the target signal 2 saturates the first sensing unit 12. Then the step S40 is performed, in which step the control unit 10 rejects the first sensing value and accepts the second sensing value. On the contrary, when the first sensing value is smaller than the first sensing upper limit, it means that the first sensing unit 12 is not saturated. Then the step S42 is performed, in which the control unit 10 rejects the second sensing value and accepts the first sensing value.

By using the disposition of components and steps described above, the high-dynamic-range sensing device 1 according to the present invention can use the control unit 10 to select the one of the first and second sensing values given by the first and second sensing units 12, 14 with a better sensing effect. In addition, because the control unit 10 needs to compare the first sensing value and the first sensing upper limit only, the quantity of computation is few. Thereby, it takes a short time to decide whether to accept or reject the first and second sensing values.

As shown in FIG. 1C, the high-dynamic-range sensing device 1 according to the present embodiment is applied to optical sensing. The control unit 10, the first sensing unit 12, and the second sensing unit 14 are arranged in a matrix form as shown in the figure. The control unit 10 is placed at the center; the first and second sensing units 12, 14 surround the control unit 10 alternately. In this way, the first and second sensing unit 12, 14 can both have excellent sensing efficacy on the target signal 2.

Please refer again to FIGS. 1A and 1B. The high-dynamic-range sensing device 1 according to the present invention can further comprises a processing unit 16, which is connected electrically with the control unit 10 and receives the first or second sensing value not rejected by the control unit 10. According to the sensing method of high-dynamic-range sensing device, the following steps can be further included after the steps S40 and S42:
Step S50: The processing unit receives the second sensing value; and
Step S52: The processing unit receives the first sensing value.

The step S50 is performed after the step S40. After the control unit 10 rejects the first sensing value, it transmits the second sensing value to the processing unit 16. The step S52 is performed after the step S42. After the control unit 10 rejects the second sensing value, it transmits the first sensing value to the processing unit 16. The processing unit 16 can further operate and use the first or second sensing values.

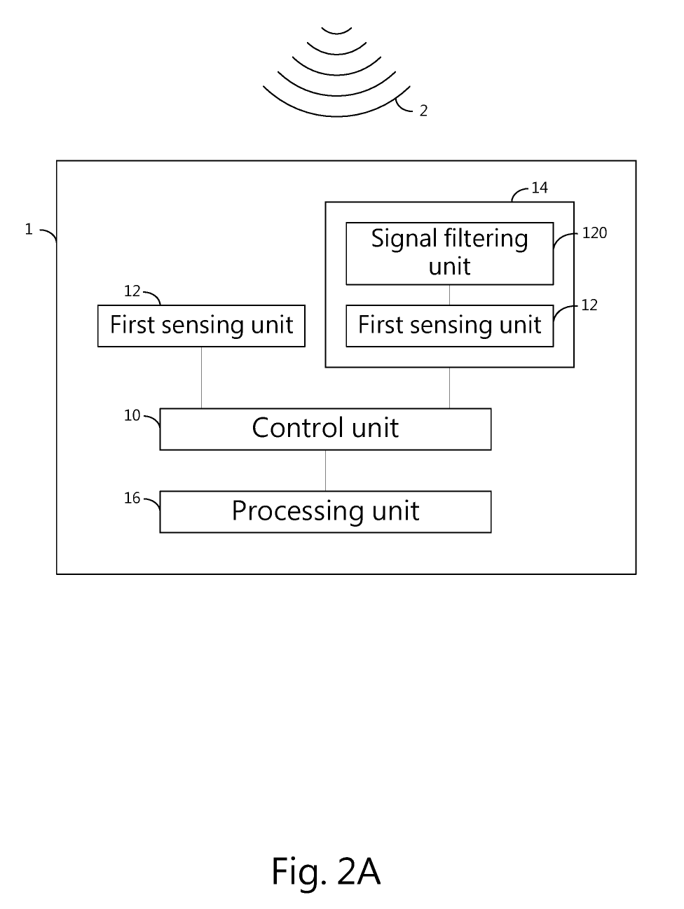

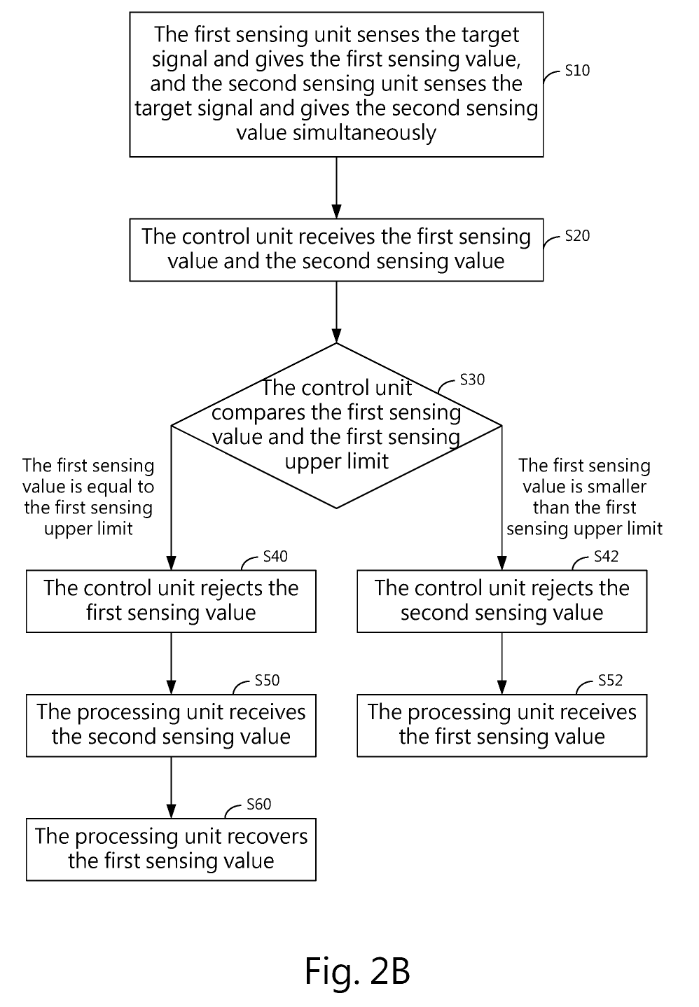

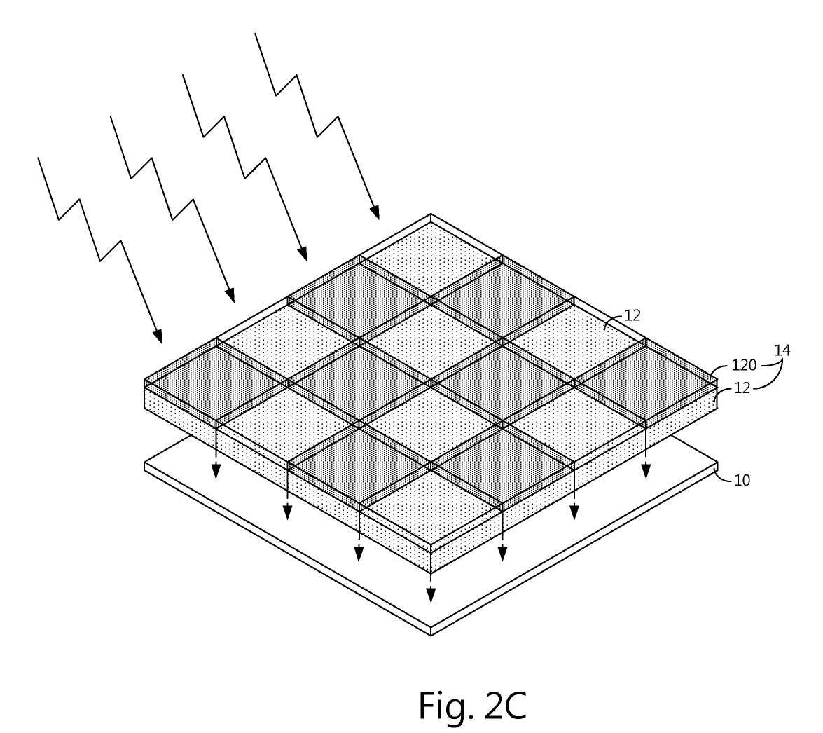

Please refer to FIGS. 2A, 2B, and 2C, which show a schematic diagram of component connection, a flowchart, and a schematic diagram of device structure according to a second preferred embodiment of the present invention. As shown in FIG. 2A, the main difference between the present embodiment and the first one is that the second sensing unit 14 according to the present embodiment is formed by the first sensing unit 12 and a signal filtering unit 120. The signal filtering unit 120 is disposed between the first sensing unit 12 and the target signal 2 for filtering the target signal 2.

The target signal 2 filtered by the signal filtering unit 120 will make the first sensing unit 12 contained in the second sensing unit 14 produce a lower second sensing value, which is equivalent to adjusting the originally lower first sensing upper limit and first sensing lower limit of the first sensing unit 12 to the higher second sensing upper limit and second sensing lower limit by disposing the signal filtering unit 120.

As shown in FIG. 2B, in the step S30, the control unit 10 still judges the acceptance and rejection of the first and second sensing values by comparing the first sensing value and the first sensing upper limit. Because the second sensing value is given by sensing, instead of the real value, the target signal 2 filtered by the signal filtering unit 120, according to the present embodiment, the following step is further included after the step S50:
Step S60: The processing unit recovers the first sensing value.

When the signal filtering unit 120 filters the target signal 2, the target signal 2 can be lowered by a ratio. In the step S60, the processing unit 16 recovers the second sensing value according to the ratio. For example, the signal filtering unit 120 can filter the target signal 2 by 20%. Then the processing unit 16 should recover the second sensing value by 125% for giving the real value of the target signal 2.

By using the disposition of components and steps described above, according to the high-dynamic-range sensing device 1 of the present invention, the first sensing unit 12 can be used as the second sensing unit 14 by disposing the signal filtering unit 120. When the second sensing unit 14 causes the first sensing unit 12 to saturate, the unsaturated second sensing unit 14 can be used for giving the second sensing value. Then the second sensing value is recovered to the real value of the target signal 2.

As shown in FIG. 2C, the high-dynamic-range sensing device 1 according to the present embodiment can also be applied to optical sensing. The signal filtering units 120 are arranged alternately, so that the first and second sensing unit 12, 14 are distributed interlacedly like a checkerboard. This arrangement enables the first and second sensing units 12, 14 to have excellent sensing effects on the target signal 2. Besides, the first and second sensing values given by the first and second units 12, 14 are transmitted to the control unit 10.

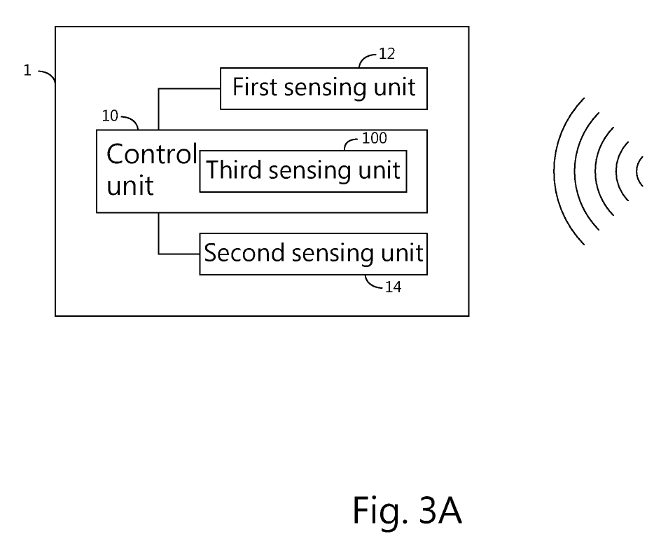

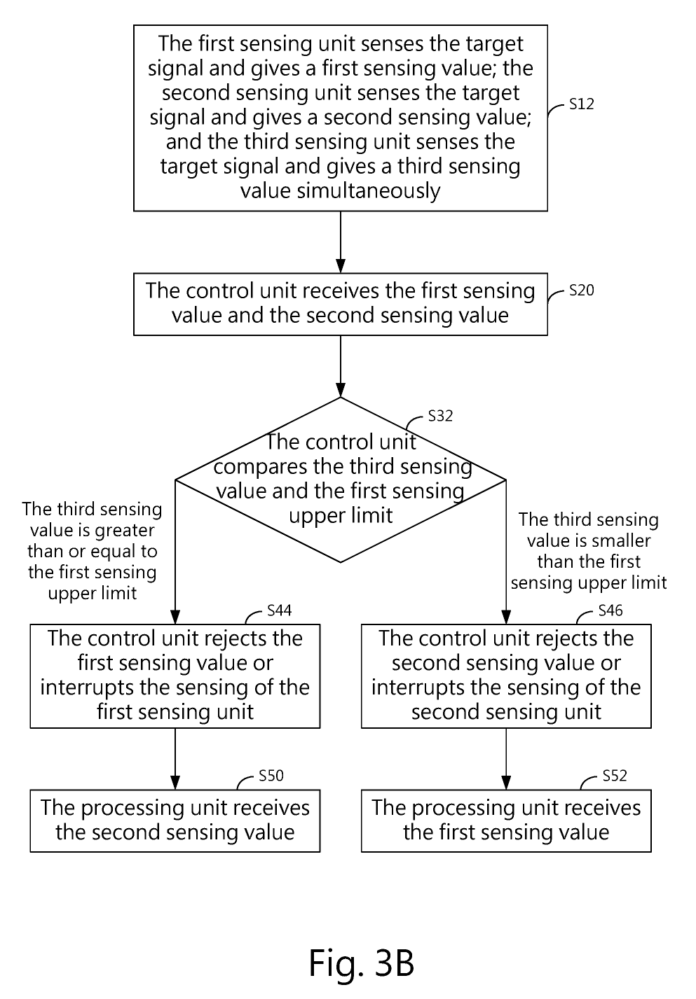

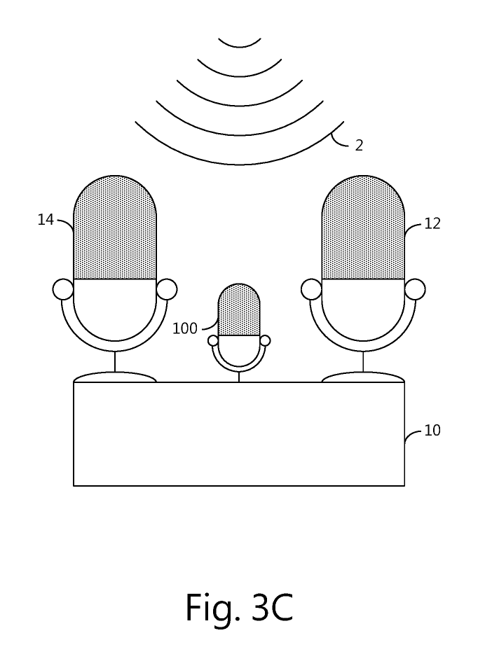

Please refer to FIGS. 3A, 3B, and 3C, which show a schematic diagram of component connection, a flowchart, and a schematic diagram of device structure according to a third preferred embodiment of the present invention. As shown in FIG. 3A, the main difference between the present embodiment and the first one is that the control unit 10 according to the present embodiment further comprises a third sensing unit 100. Likewise, the third sensing unit 100 can sense the target signal 2 and give a third sensing value. The control unit 10 according to the present embodiment determines the acceptance or rejection of the first and second sensing values or switches between the first and second sensing units 12, 14 according to the third sensing value.

The upper limit of the third sensing unit 100 for sensing signal is a third sensing upper limit; the lower limit thereof is a third sensing lower limit. The range between the third sensing lower limit and the third sensing upper limit is called a third sensing range of the third sensing unit 100. The third sensing range should cover the first sensing upper limit, so that the third sensing value can be used for judging if the first sensing unit 12 has saturated.

As shown in FIG. 3B, according to the disposition of the third sensing unit 100, the step S10 is adjusted to a step S12; the step S30 is adjusted to a step S32; the step S40 is adjusted to a step S44; and the step S42 is adjusted to a step S46.
Step S12: The first sensing unit senses the target signal and gives a first sensing value; the second sensing unit senses the target signal and gives a second sensing value; and the third sensing unit senses the target signal and gives a third sensing value simultaneously;
Step S32: The control unit compares the third sensing value and the first sensing upper limit;
Step S44: The control unit rejects the first sensing value or interrupts the sensing of the first sensing unit; and
Step S46: The control unit rejects the second sensing value or interrupts the sensing of the second sensing unit.

In the step S12, the first, second, and third sensing units 12, 14, 100 sense the target signal 2 simultaneously and give the first, second, and third sensing values, respectively.

As described above, the control unit 10 according to the present embodiment determines the acceptance or rejection of the first and second sensing values or switches between the first and second sensing units 12, 14 according to the third sensing value. Thereby, in the step S32, the control unit 10 compares the third sensing value and the first sensing upper limit for judging whether the first sensing value or the second sensing value should be rejected, or whether the sensing of the first sensing unit 12 or the second sensing unit 14 should be interrupted.

When the third sensing value is greater than or equal to the first sensing upper limit, it means that the target signal 2 saturates the first sensing unit 12. At this time, the step S44 is performed, in which the control unit 10 rejects the first sensing value and accepts the second sensing value, or interrupts the sensing of the first sensing unit 12. On the contrary, when the third sensing value is smaller than the first sensing upper limit, it means that the first sensing unit 12 has not saturated yet. Then the step S46 is performed, in which the control unit 10 rejects the second sensing value and accepts the first sensing value, or interrupts the sensing of the second sensing unit 12. Because the control unit 10 adopts the third sensing value, instead of the first sensing value given by the first sensing unit 12, as the basis for judgment, interruption of the first sensing unit 12 will not influence the normal operation of the high-dynamic-range sensing device 1 according to the present embodiment.

By using the disposition of components and steps described above, the high-dynamic-range sensing device 1 according to the present invention acquires the third sensing value given by the third sensing unit 100. The third sensing value replaces the first sensing value and is used as the basis for judgment by the control unit 10. Consequently, in addition to accepting or rejecting the first and second sensing values, the sensing of the first or second sensing unit 12, 14 can be further interrupted. Hence, the control unit 10 switches between the first and second sensing units 12, 14.

As shown in FIG. 2C, the high-dynamic-range sensing device 1 according to the present embodiment can also be applied to sensing acoustic waves. The third sensing unit 100, which is capable of sensing the volume of sound, in the control unit 10 can sense the target signal 2. Switches are performed between two microphones having different sound sensing ranges, which are just the first and second sensing units 12, 14. Thereby, when the volume is smaller, the first sensing unit 12 having a lower first sensing lower limit (more sensitive) can be adopted. When the volume is larger, the second sensing unit 14 having a higher second sensing upper limit can be used instead for avoiding noise interference such as popping due to excessive volume of sound.

To sum up, the present invention provides a high-dynamic-range sensing device and the sensing method thereof. In the sensing method, the sensing units give sensing values, and then the control unit compares the sensing values and the upper sensing limit of the sensing units, respectively. When a sensing value is equal to the upper sensing limit, the control unit rejects the sensing value or interrupts the sensing of the sensing unit thereof. Thereby, the sensing device quickly excludes the sensing units that obtain saturated signals and their sensing values and thus switches between the alternative sensing units with different sensing ranges or picks up the optimum one of the sensing values.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A high-dynamic-range sensing device, comprising:
a first sensing unit, having a first sensing upper limit, sensing a target signal and giving a first sensing value;
a second sensing unit, having a second sensing upper limit greater than said first sensing upper limit, sensing said target signal and giving a second sensing value; and
a control unit, connected electrically with said first sensing unit and said second sensing unit, receiving said first sensing value and said second sensing value, including a third sensing unit, said third sensing unit sensing said target signal and giving a third sensing value, and rejecting said first sensing value or interrupting the sensing of said first sensing unit when said third sensing value is greater than or equal to said first sensing upper limit.

2. The high-dynamic-range sensing device of claim 1, wherein said second sensing unit comprises a first sensing unit and a signal filtering unit, and said signal filtering unit filters said target signal to make said second sensing value smaller than said first sensing upper limit.

3. The high-dynamic-range sensing device of claim 2, and further comprising a processing unit, connected electrically to said control unit, and recovering said second sensing value to comply with said target signal according to the ratio by which said signal filtering unit filters said target signal.

4. The high-dynamic-range sensing device of claim 1, wherein said control unit rejects said second sensing value or interrupts the sensing of said second sensing unit when said third sensing value is smaller than said first sensing upper limit.

5. The high-dynamic-range sensing device of claim 1, and further comprising a processing unit, connected electrically to said control unit, and receiving said first sensing value or said second sensing value not rejected by said control unit.

6. A sensing method of high-dynamic-range sensing device, used in a high-dynamic-range sensing device comprising a first sensing unit having a first sensing upper limit, a second sensing unit having a second sensing upper limit, a third sensing unit, and a control unit connected electrically between said first sensing unit and said second sensing unit, said first sensing upper limit smaller than said second sensing upper limit, comprising steps of:
said first sensing unit sensing a target signal and giving a first sensing value, said second sensing unit sensing said target signal and giving a second sensing value, and said third sensing unit sensing said target signal and giving a third sensing value simultaneously;
said control unit receiving said first sensing value and said second sensing value;
said control unit rejecting said first sensing value if said third sensing value is greater than or equal to said first sensing upper limit; and
said control unit rejecting said second sensing value if said third sensing value is smaller than said first sensing upper limit.

7. The sensing method of high-dynamic-range sensing device of claim 6, wherein said second sensing unit comprises a first sensing unit and a signal filtering unit, said signal filtering unit filtering said target signal to make said second sensing value smaller than said first sensing upper limit, and after said step of said control unit rejecting said first sensing value further comprising a steps of a processing unit connected electrically to said control unit receiving said second sensing value and recovering said second sensing value to comply with said target signal according to the ratio by which said signal filtering unit filters said target signal.

8. The sensing method of high-dynamic-range sensing device of claim 6, and further comprising a step of a processing unit connected electrically to said control unit receiving said first sensing value or said second sensing value not rejected by said control unit.
